(19) United States
(12) Patent Application Publication
(10) Pub. No.: US 2020/0298854 A1
(43) Pub. Date: Sep. 24, 2020

(54) HYBRID VEHICLE AND METHOD FOR CONTROLLING HYBRID VEHICLE

(71) Applicant: TOYOTA JIDOSHA KABUSHIKI KAISHA, Toyota-shi (JP)

(72) Inventors: Koichi Yonezawa, Toyota-shi (JP); Satoshi Yoshizaki, Gotenba-shi (JP); Osamu Maeda, Toyota-shi (JP); Daigo Ando, Nagoya-shi (JP); Yoshikazu Asami, Gotenba-shi (JP); Kenji Itagaki, Suntou-gun (JP); Shunsuke Oyama, Nagakute-shi (JP); Koichiro Muta, Okazaki-shi (JP)

(73) Assignee: TOYOTA JIDOSHA KABUSHIKI KAISHA, Toyota-shi (JP)

(21) Appl. No.: 16/809,672

(22) Filed: Mar. 5, 2020

(30) Foreign Application Priority Data
Mar. 20, 2019 (JP) 2019-053049

(51) Int. Cl. B60W 30/188; B60W 20/10; B60W 10/06; B60W 10/08

(52) U.S. Cl. CPC B60W 30/188; B60W 20/10; B60W 10/06; B60W 2710/083; B60W 2510/0638; B60W 2510/0657; B60W 10/08

(57) ABSTRACT

An HV-ECU performs processing including calculating estimated engine torque based on a previous value of a time constant, setting as the time constant, a first value corresponding to a forced induction range when engine torque is determined as being in the forced induction range, setting as the time constant, a second value corresponding to a non-forced induction range when engine torque is determined as not being in the forced induction range, calculating a feedforward term Tgff, calculating a feedback term Tgfb, calculating a torque command value for a first MG, and outputting a first MG torque command.

This nonprovisional application is based on Japanese Patent Application No. 2019-053049 filed with the Japan Patent Office on Mar. 20, 2019, the entire contents of which are hereby incorporated by reference.

### BACKGROUND

### Field

The present disclosure relates to control of a hybrid vehicle incorporating a motor and an engine including a forced induction device as drive sources.

### Description of the Background Art

A hybrid vehicle that incorporates a generator and an engine, includes a power storage charged by operations of the generator using motive power of the engine, and runs with motive power of the engine has conventionally been known. Some engines mounted on such a hybrid vehicle include a forced induction device such as a turbo charger.

For example, Japanese Patent Laying-Open No. 2015-58924 discloses a hybrid vehicle incorporating a motor, a generator, and an engine including a forced induction device.

### SUMMARY

In the hybrid vehicle described above, when a rotation speed of the engine is controlled by using torque generated by the generator, estimation of engine torque may be required. In such a case, for example, engine torque is estimated in consideration of response delay such as first-order delay behind issuance of an output command to the engine. In the engine including a forced induction device, however, responsiveness of engine torque is different between a forced induction range in which forced induction by the forced induction device is performed and a non-forced induction range and hence engine torque may not accurately be estimated when response delay is taken into consideration similarly in both of these regions.

An object of the present disclosure is to provide a hybrid vehicle that accurately estimates engine torque in accordance with a state of forced induction by a forced induction device and a method of controlling a hybrid vehicle.

A hybrid vehicle according to one aspect of the present disclosure includes an engine including a forced induction device, a motor generator that generates electric power by using motive power of the engine, a power divider that divides motive power output from the engine into motive power to be transmitted to the motor generator and motive power to be transmitted to a drive wheel, and a controller that carries out torque control of the motor generator for setting a rotation speed of the engine to a target value by using engine torque estimated in consideration of responsiveness to an output command to the engine. The controller sets a time constant that determines responsiveness differently between a forced induction range in which forced induction by the forced induction device is performed and a non-forced induction range.

By doing so, the time constant that determines responsiveness is set differently between the forced induction range and the non-forced induction range and hence an appropriate time constant can be set in accordance with a state of forced induction by the forced induction device. Therefore, engine torque can accurately be estimated in each of the forced induction range and the non-forced induction range. Accuracy in torque control of the motor generator can thus be improved.

In one embodiment, the controller changes the time constant such that a value thereof in the forced induction range is greater than a value thereof in the non-forced induction range.

By doing so, an appropriate time constant can be set in each of the forced induction range and the non-forced induction range. Therefore, engine torque can accurately be estimated in each of the forced induction range and the non-forced induction range.

Furthermore, in one embodiment, the hybrid vehicle further includes a detector that detects an atmospheric pressure. When the engine torque exceeds a threshold value, the controller determines the engine torque as being in the forced induction range. When the engine torque is lower than the threshold value, the controller determines the engine torque as being in the non-forced induction range. The controller sets the threshold value such that the threshold value when the atmospheric pressure is low is smaller than the threshold value when the atmospheric pressure is high.

By doing so, even when responsiveness of engine torque is varied with variation in atmospheric pressure, the time constant can be changed in accordance with the state of forced induction by the forced induction device. Therefore, engine torque can accurately be estimated in each of the forced induction range and the non-forced induction range.

A method of controlling a hybrid vehicle according to another aspect of the present disclosure is a method of controlling a hybrid vehicle, the hybrid vehicle including an engine including a forced induction device, a motor generator that generates electric power by using motive power of the engine, and a power divider that divides motive power output from the engine into motive power to be transmitted to the motor generator and motive power to be transmitted to a drive wheel. The method includes carrying out torque control of the motor generator for setting a rotation speed of the engine to a target value by using engine torque estimated in consideration of responsiveness to an output command to the engine and setting a time constant that determines responsiveness differently between a forced induction range in which forced induction by the forced induction device is performed and a non-forced induction range.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram showing an exemplary configuration of a drive system of a hybrid vehicle.

FIG. 2 is a diagram showing an exemplary configuration of an engine including a turbo charger.

FIG. 3 is a block diagram showing an exemplary configuration of a controller.

FIG. 4 is a flowchart showing exemplary processing in coordinated control in the hybrid vehicle.

FIG. 5 is a diagram for illustrating setting of an operating point on a predetermined operating line.

FIG. 6 is a block diagram for illustrating a method of setting a torque command value for a first MG.

FIG. 7 is a diagram for illustrating a method of calculating estimated engine torque.

FIG. 8 is a flowchart showing exemplary processing for outputting a first MG torque command performed by an HV-ECU.

FIG. 9 is a diagram for illustrating an exemplary operation by the HV-ECU.

FIG. 10 is a flowchart showing exemplary processing for outputting the first MG torque command performed by the HV-ECU in a modification.

FIG. 11 is a diagram for illustrating an exemplary operation by the HV-ECU in the modification.

### DESCRIPTION OF THE PREFERRED EMBODIMENTS

An embodiment of the present disclosure will be described in detail below with reference to the drawings. The same or corresponding elements in the drawings have the same reference characters allotted and description thereof will not be repeated.

<As to Drive System of Hybrid Vehicle>

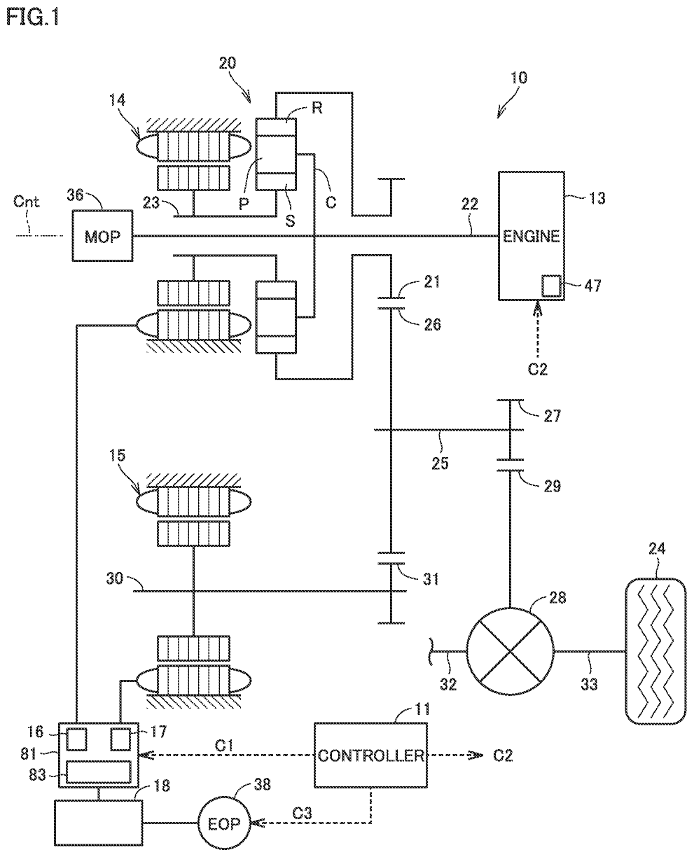

FIG. 1 is a diagram showing an exemplary configuration of a drive system of a hybrid vehicle (which is simply denoted as a vehicle below) 10. As shown in FIG. 1, vehicle 10 includes as a drive system, a controller 11 as well as an engine 13, a first motor generator (which is denoted as a first MG below) 14, and a second motor generator (which is denoted as a second MG below) 15 that serve as motive power sources for running. Engine 13 includes a turbo charger 47 representing one example of a forced induction device. First MG 14 and second MG 15 each perform a function as a motor that outputs torque by being supplied with driving electric power and a function as a generator that generates electric power by being supplied with torque. An alternating current (AC) rotating electric machine is employed for first MG 14 and second MG 15. The AC rotating electric machine includes, for example, a permanent magnet synchronous motor including a rotor having a permanent magnet embedded.

First MG 14 and second MG 15 are electrically connected to a battery 18 with a power control unit (PCU) 81 being interposed. PCU 81 includes a first inverter 16 that supplies and receives electric power to and from first MG 14, a second inverter 17 that supplies and receives electric power to and from second MG 15, battery 18, and a converter 83 that supplies and receives electric power to and from first inverter 16 and second inverter 17.

For example, converter 83 can up-convert electric power from battery 18 and supply up-converted electric power to first inverter 16 or second inverter 17. Alternatively, converter 83 can down-convert electric power supplied from first inverter 16 or second inverter 17 and supply down-converted electric power to battery 18.

First inverter 16 can convert direct current (DC) power from converter 83 into AC power and supply AC power to first MG 14. Alternatively, first inverter 16 can convert AC power from first MG 14 into DC power and supply DC power to converter 83.

Second inverter 17 can convert DC power from converter 83 into AC power and supply AC power to second MG 15. Alternatively, second inverter 17 can convert AC power from second MG 15 into DC power and supply DC power to converter 83.

PCU 81 charges battery 18 with electric power generated by first MG 14 or second MG 15 or drives first MG 14 or second MG 15 with electric power from battery 18.

Battery 18 includes, for example, a lithium ion secondary battery or a nickel metal hydride secondary battery. The lithium ion secondary battery is a secondary battery in which lithium is adopted as a charge carrier, and may include not only a general lithium ion secondary battery containing a liquid electrolyte but also what is called an all-solid-state battery containing a solid electrolyte. Battery 18 should only be a power storage that is at least rechargeable, and for example, an electric double layer capacitor may be employed instead of the secondary battery.

Engine 13 and first MG 14 are coupled to a planetary gear mechanism 20. Planetary gear mechanism 20 transmits drive torque output from engine 13 by dividing drive torque into drive torque to first MG 14 and drive torque to an output gear 21, and represents an exemplary power divider in the embodiment of the present disclosure. Planetary gear mechanism 20 includes a single-pinion planetary gear mechanism and is arranged on an axis Cnt coaxial with an output shaft 22 of engine 13.

Planetary gear mechanism 20 includes a sun gear S, a ring gear R arranged coaxially with sun gear S, a pinion gear P meshed with sun gear S and ring gear R, and a carrier C holding pinion gear P in a rotatable and revolvable manner. Output shaft 22 is coupled to carrier C. A rotor shaft 23 of first MG 14 is coupled to sun gear S. Ring gear R is coupled to output gear 21. Output gear 21 represents one of output elements for transmitting drive torque to a drive wheel 24.

In planetary gear mechanism 20, carrier C to which drive torque output from engine 13 is transmitted serves as an input element, ring gear R that outputs drive torque to output gear 21 serves as an output element, and sun gear S to which rotor shaft 23 is coupled serves as a reaction force element. Planetary gear mechanism 20 divides motive power output from engine 13 into motive power on a side of first MG 14 and motive power on a side of output gear 21. First MG 14 is controlled to output torque in accordance with an engine rotation speed.

A countershaft 25 is arranged in parallel to axis Cnt. Countershaft 25 is attached to a driven gear 26 meshed with output gear 21. A drive gear 27 is attached to countershaft 25, and drive gear 27 is meshed with a ring gear 29 in a differential gear 28 representing a final reduction gear. A drive gear 31 attached to a rotor shaft 30 in second MG 15 is meshed with driven gear 26. Therefore, drive torque output from second MG 15 is added to drive torque output from output gear 21 in a part of driven gear 26. Drive torque thus combined is transmitted to drive wheel 24 with driveshafts 32 and 33 extending laterally from differential gear 28 being interposed. As drive torque is transmitted to drive wheel 24, driving force is generated in vehicle 10.

A mechanical oil pump (which is denoted as an MOP below) 36 is provided coaxially with output shaft 22. MOP 36 delivers lubricating oil with a cooling function, for example, to planetary gear mechanism 20, first MG 14, second MG 15, and differential gear 28. Vehicle 10 further includes an electric oil pump (which is denoted as an EOP below) 38. EOP 38 is driven by electric power supplied from battery 18 when operation of engine 13 is stopped, and it delivers lubricating oil to planetary gear mechanism 20, first MG 14, second MG 15, and differential gear 28 in a manner the same as or similar to MOP 36.

<As to Configuration of Engine>

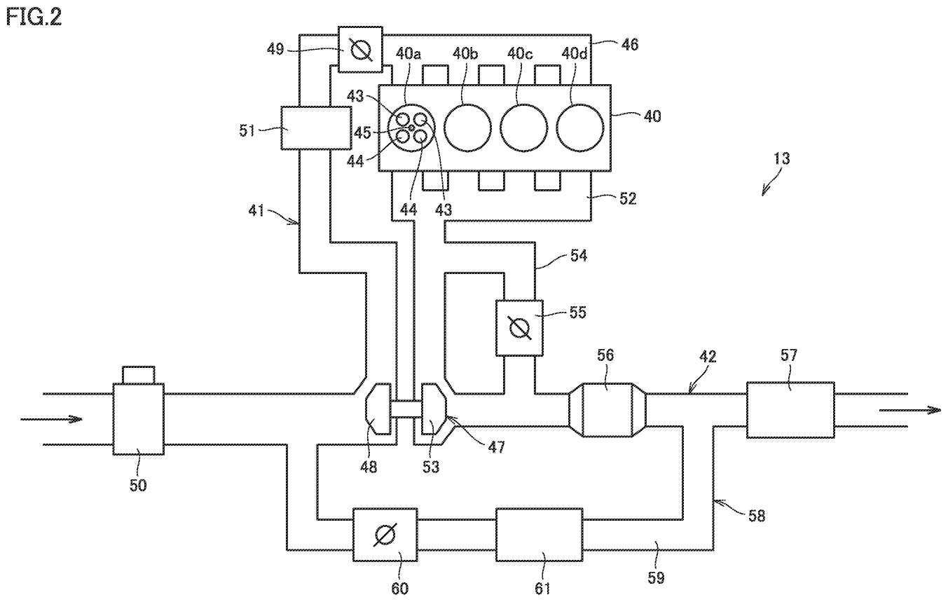

FIG. 2 is a diagram showing an exemplary configuration of engine 13 including turbo charger 47. Engine 13 is, for example, an in-line four-cylinder spark ignition internal combustion engine. As shown in FIG. 2, engine 13 includes, for example, an engine main body 40 formed with four cylinders 40a, 40b, 40c, and 40d being aligned in one direction.

One ends of intake ports and one ends of exhaust ports formed in engine main body 40 are connected to cylinders 40a, 40b, 40c, and 40d. One end of the intake port is opened and closed by two intake valves 43 provided in each of cylinders 40a, 40b, 40c, and 40d, and one end of the exhaust port is opened and closed by two exhaust valves 44 provided in each of cylinders 40a, 40b, 40c and 40d. The other ends of the intake ports of cylinders 40a, 40b, 40c, and 40d are connected to an intake manifold 46. The other ends of the exhaust ports of cylinders 40a, 40b, 40c, and 40d are connected to an exhaust manifold 52.

In the present embodiment, engine 13 is, for example, a direct injection engine and fuel is injected into each of cylinders 40a, 40b, 40c, and 40d by a fuel injector (not shown) provided at the top of each cylinder. An air fuel mixture of fuel and intake air in cylinders 40a, 40b, 40c, and 40d is ignited by an ignition plug 45 provided in each of cylinders 40a, 40b, 40c, and 40d.

FIG. 2 shows intake valve 43, exhaust valve 44, and ignition plug 45 provided in cylinder 40a and does not show intake valve 43, exhaust valve 44, and ignition plug 45 provided in other cylinders 40b, 40c, and 40d.

Engine 13 is provided with turbo charger 47 that uses exhaust energy to boost suctioned air. Turbo charger 47 includes a compressor 48 and a turbine 53.

An intake air passage 41 has one end connected to intake manifold 46 and the other end connected to an air inlet. Compressor 48 is provided at a prescribed position in intake air passage 41. An air flow meter 50 that outputs a signal in accordance with a flow rate of air that flows through intake air passage 41 to controller 11 is provided between the other end (air inlet) of intake air passage 41 and compressor 48. An intercooler 51 that cools intake air pressurized by compressor 48 is disposed in intake air passage 41 provided downstream from compressor 48. An intake throttle valve (throttle valve) 49 that can regulate a flow rate of intake air that flows through intake air passage 41 is provided between intercooler 51 and one end of intake air passage 41.

An exhaust passage 42 has one end connected to exhaust manifold 52 and the other end connected to a muffler (not shown). Turbine 53 is provided at a prescribed position in exhaust passage 42. In exhaust passage 42, a bypass passage 54 that bypasses exhaust upstream from turbine 53 to a portion downstream from turbine 53 and a waste gate valve 55 provided in the bypass passage and capable of regulating a flow rate of exhaust guided to turbine 53 are provided. Therefore, a flow rate of exhaust that flows into turbine 53, that is, a boost pressure of suctioned air, is regulated by controlling a position of waste gate valve 55. Exhaust that passes through turbine 53 or waste gate valve 55 is purified by a start-up converter 56 and an aftertreatment apparatus 57 provided at prescribed positions in exhaust passage 42, and thereafter emitted into the atmosphere. Aftertreatment apparatus 57 contains, for example, a three-way catalyst.

Engine 13 is provided with an exhaust gas recirculation (EGR) apparatus 58 that has exhaust flow into intake air passage 41. EGR apparatus 58 includes an EGR passage 59, an EGR valve 60, and an EGR cooler 61. EGR passage 59 allows some of exhaust to be taken out of exhaust passage 42 as EGR gas and guides EGR gas to intake air passage 41. EGR valve 60 regulates a flow rate of EGR gas that flows through EGR passage 59. EGR cooler 61 cools EGR gas that flows through EGR passage 59. EGR passage 59 connects a portion of exhaust passage 42 between start-up converter 56 and aftertreatment apparatus 57 to a portion of intake air passage 41 between compressor 48 and air flow meter 50.

<As to Configuration of Controller>

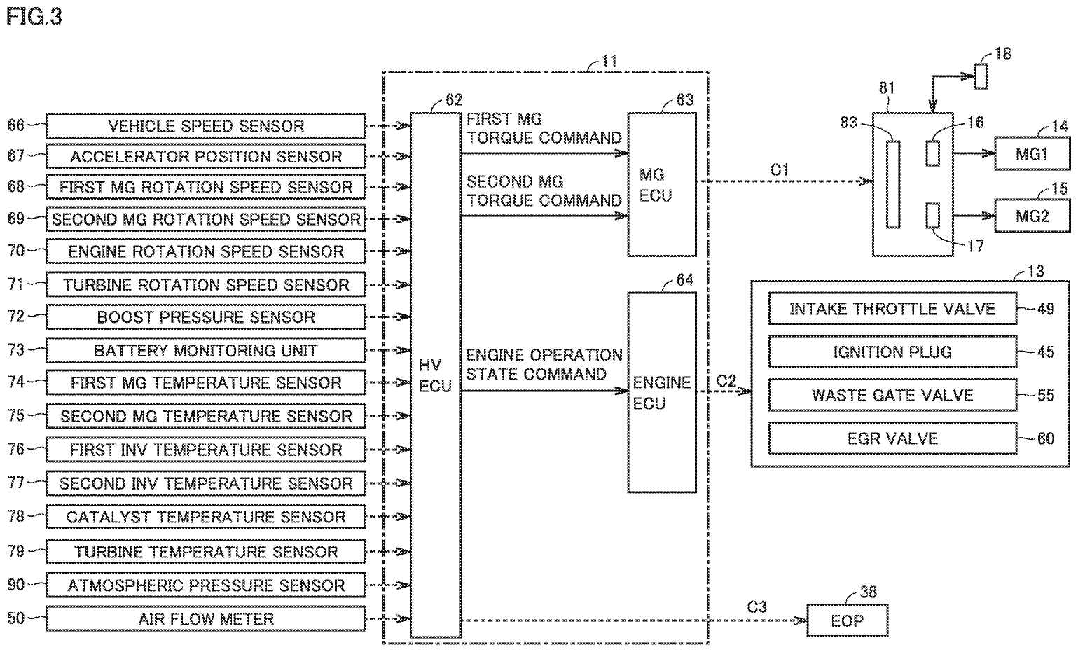

FIG. 3 is a block diagram showing an exemplary configuration of controller 11. As shown in FIG. 3, controller 11 includes a hybrid vehicle (HV)-electronic control unit (ECU) 62, an MG-ECU 63, and an engine ECU 64.

HV-ECU 62 is a controller that controls engine 13, first MG 14, and second MG 15 in coordination. MG-ECU 63 is a controller that controls an operation by PCU 81. Engine ECU 64 is a controller that controls an operation by engine 13.

HV-ECU 62, MG-ECU 63, and engine ECU 64 each include an input and output apparatus that supplies and receives signals to and from various sensors and other ECUs that are connected, a storage that serves for storage of various control programs or maps (including a read only memory (ROM) and a random access memory (RAM)), a central processing unit (CPU) that executes a control program, and a counter that counts time.

Though FIG. 3 illustrates a configuration in which HV-ECU 62, MG-ECU 63, and engine ECU 64 are separately provided by way of example, the ECUs may be integrated as a single ECU.

A vehicle speed sensor 66, an accelerator position sensor 67, a first MG rotation speed sensor 68, a second MG rotation speed sensor 69, an engine rotation speed sensor 70, a turbine rotation speed sensor 71, a boost pressure sensor 72, a battery monitoring unit 73, a first MG temperature sensor 74, a second MG temperature sensor 75, a first INV temperature sensor 76, a second INV temperature sensor 77, a catalyst temperature sensor 78, a turbine temperature sensor 79, an atmospheric pressure sensor 90, and air flow meter 50 are connected to HV-ECU 62.

Vehicle speed sensor 66 detects a speed of vehicle 10 (vehicle speed). Accelerator position sensor 67 detects an amount of pressing of an accelerator pedal (accelerator position). First MG rotation speed sensor 68 detects a rotation speed of first MG 14. Second MG rotation speed sensor 69 detects a rotation speed of second MG 15. Engine rotation speed sensor 70 detects a rotation speed of output shaft 22 of engine 13 (engine rotation speed). Turbine rotation speed sensor 71 detects a rotation speed of turbine 53 of turbo charger 47. Boost pressure sensor 72 detects a boost pressure of engine 13. First MG temperature sensor 74 detects an internal temperature of first MG 14 such as a temperature associated with a coil or a magnet. Second MG temperature sensor 75 detects an internal temperature of second MG 15 such as a temperature associated with a coil or a magnet. First INV temperature sensor 76 detects a temperature of first inverter 16 such as a temperature associated with a switching element. Second INV temperature sensor 77 detects a temperature of second inverter 17 such as a temperature associated with a switching element. Catalyst temperature sensor 78 detects a temperature of aftertreatment apparatus 57. Turbine temperature sensor 79 detects a temperature of turbine 53. Atmospheric pressure sensor 90 detects an atmospheric pressure. Various sensors described above output signals indicating results of detection to HV-ECU 62.

Battery monitoring unit 73 obtains a state of charge (SOC) representing a ratio of a remaining amount of charge to a full charge capacity of battery 18 and outputs a signal indicating the obtained SOC to HV-ECU 62.

Battery monitoring unit 73 includes, for example, a sensor that detects a current, a voltage, and a temperature of battery 18. Battery monitoring unit 73 obtains an SOC by calculating the SOC based on the detected current, voltage, and temperature of battery 18.

Various known approaches such as an approach by accumulation of current values (coulomb counting) or an approach by estimation of an open circuit voltage (OCV) can be adopted as a method of calculating an SOC. <As to Control of Running of Vehicle>

Vehicle 10 configured as above can be set or switched to such a running mode as a hybrid (HV) running mode in which engine 13 and second MG 15 serve as motive power sources and an electric (EV) running mode in which the vehicle runs with engine 13 remaining stopped and second MG 15 being driven by electric power stored in battery 18. Setting of and switching to each mode is made by HV-ECU 62. HV-ECU 62 controls engine 13, first MG 14, and second MG 15 based on the set or switched running mode.

The EV running mode is selected, for example, in a low-load operation region where a vehicle speed is low and requested driving force is low, and refers to a running mode in which an operation by engine 13 is stopped and second MG 15 outputs driving force.

The HV running mode is selected in a high-load operation region where a vehicle speed is high and requested driving force is high, and refers to a running mode in which combined torque of drive torque of engine 13 and drive torque of second MG 15 is output.

In the HV running mode, in transmitting drive torque output from engine 13 to drive wheel 24, first MG 14 applies reaction force to planetary gear mechanism 20. Therefore, sun gear S functions as a reaction force element. In other words, in order to apply engine torque to drive wheel 24, first MG 14 is controlled to output reaction torque against engine torque. In this case, regenerative control in which first MG 14 functions as a generator can be carried out.

HV-ECU 62 further transmits a control signal C3 based on an operation state including the running mode to EOP 38 and controls drive of EOP 38. For example, when engine torque corresponding to a set operating point exceeds a threshold value, HV-ECU 62 requests of engine ECU 64 to increase a boost pressure. Though an example in which the threshold value is constant regardless of variation in engine rotation speed is described by way of example in the present embodiment, the threshold value may be set to vary with the engine rotation speed. For example, when the engine rotation speed is in a high rotation speed range, a threshold value smaller than in a low rotation speed range may be set.

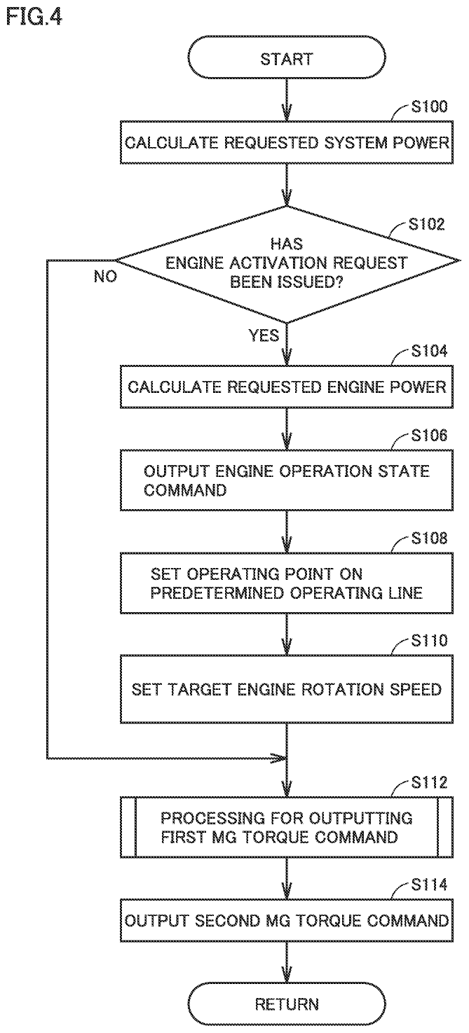

Control of engine 13, first MG 14, and second MG 15 in coordination while vehicle 10 operates will be described below with reference to FIG. 4. FIG. 4 is a flowchart showing exemplary processing in coordinated control in the hybrid vehicle.

In a step (a step being denoted as S below) 100, HV-ECU 62 calculates requested system power.

Specifically, HV-ECU 62 calculates requested driving force based on an accelerator position determined by an amount of pressing of the accelerator pedal. HV-ECU 62 calculates requested running power of vehicle 10 based on the calculated requested driving force and a vehicle speed. HV-ECU 62 calculates a value resulting from addition of requested charging and discharging power of battery 18 to requested running power as requested system power. Requested charging and discharging power of battery 18 is set, for example, in accordance with a difference from an SOC of battery 18 and a predetermined control central value.

In S102, HV-ECU 62 determines whether or not activation of engine 13 has been requested in accordance with calculated requested system power. HV-ECU 62 determines that activation of engine 13 has been requested, for example, when requested system power exceeds a threshold value.

When activation of engine 13 has been requested, HV-ECU 62 sets the HV running mode as the running mode. When activation of engine 13 has not been requested, HV-ECU 62 sets the EV running mode as the running mode.

When it is determined that activation of engine 13 has been requested (YES in S102), the process proceeds to S104. Otherwise (NO in S102), the process proceeds to S112.

In S104, HV-ECU 62 calculates power requested of engine 13 (which is denoted as requested engine power below). For example, HV-ECU 62 calculates requested system power as requested engine power. For example, when requested system power exceeds an upper limit value of requested engine power, HV-ECU 62 calculates the upper limit value of requested engine power as requested engine power.

In S106, HV-ECU 62 outputs calculated requested engine power as an engine operation state command to engine ECU 64.

Engine ECU 64 transmits a control signal C2 based on the engine operation state command input from HV-ECU 62 and variously controls each component of engine 13 such as intake throttle valve 49, ignition plug 45, waste gate valve 55, and EGR valve 60.

In S108, HV-ECU 62 sets based on calculated requested engine power, an operating point of engine 13 on a predetermined operating line set in a coordinate system defined by an engine rotation speed and engine torque.

Specifically, HV-ECU 62 sets, for example, an intersection between an equal power line equal in output to requested engine power in the coordinate system and the predetermined operating line as the operating point of engine 13.

The predetermined operating line represents a trace of variation in engine torque with variation in engine rotation speed in the coordinate system, and it is set, for example, by adapting the trace of variation in engine torque high in fuel efficiency through experiments.

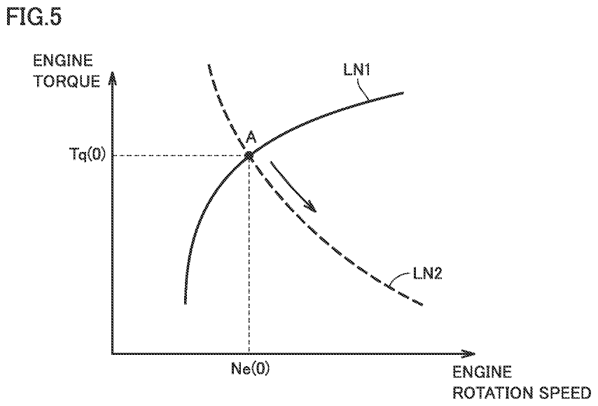

FIG. 5 is a diagram for illustrating setting of an operating point on a predetermined operating line. The ordinate in FIG. 5 represents engine torque. The abscissa in FIG. 5 represents an engine rotation speed. FIG. 5 shows a predetermined operating line LN1 (a solid line). FIG. 5 shows an equal power line LN2 (a dashed line) of requested engine power calculated in S104.

In this case, HV-ECU 62 sets as the operating point, an intersection A between the predetermined operating line (LN1 in FIG. 5) and the equal power line (LN2 in FIG. 5) of requested engine power. Specifically, intersection A at which the engine rotation speed attains to Ne(0) and engine torque attains to Tq(1) in a coordinate plane of engine torque and the engine rotation speed is set as the operating point.

In S110, HV-ECU 62 sets the engine rotation speed corresponding to the set operating point as a target engine rotation speed. In the example shown in FIG. 5, engine rotation speed Ne(0) corresponding to intersection A set as the operating point is set as the target engine rotation speed.

In S112, HV-ECU 62 outputs a first MG torque command. Specifically, HV-ECU 62 sets a torque command value for first MG 14 for setting a current engine rotation speed to the set target engine rotation speed. For example, HV-ECU 62 sets as the torque command value for first MG 14, a sum of first torque of first MG 14 for maintaining the current engine rotation speed and second torque of first MG 14 for changing the current engine rotation speed to the target engine rotation speed. More specifically, HV-ECU 62 sets as the torque command value for first MG 14, for example, the sum of first torque calculated through feedforward control based on an estimated value of engine torque (which is denoted as estimated engine torque below) and second torque calculated through feedback control based on a difference between the current engine rotation speed and the target engine rotation speed. HV-ECU 62 outputs the set torque command value for first MG 14 as the first MG torque command to MG-ECU 63. Details of a method of setting a torque command value for first MG14 will be described later. When it is determined that a request for activation of engine 13 has not been issued (NO in S102), HV-ECU 62 outputs the first MG torque command corresponding to a state that engine 13 is off.

In S114, HV-ECU 62 outputs a second MG torque command. Specifically, HV-ECU 62 calculates engine torque to be transmitted to drive wheel 24 based on the set torque command value for first MG 14 and a gear ratio of each rotary element of planetary gear mechanism 20 and sets a torque command value for second MG 15 so as to fulfill requested driving force. HV-ECU 62 outputs the set torque command value for second MG 15 as a second MG torque command to MG-ECU 63.

MG-ECU 63 calculates a current value corresponding to torque to be generated by first MG 14 and second MG 15 and a frequency thereof based on the first MG torque command and the second MG torque command input from HV-ECU 62, and outputs a control signal C 1 including the calculated current value and the frequency thereof to PCU 81. Torque of first MG 14 and torque of second MG 15 are thus controlled.

<As to Setting of Torque Command Value for First MG 14>

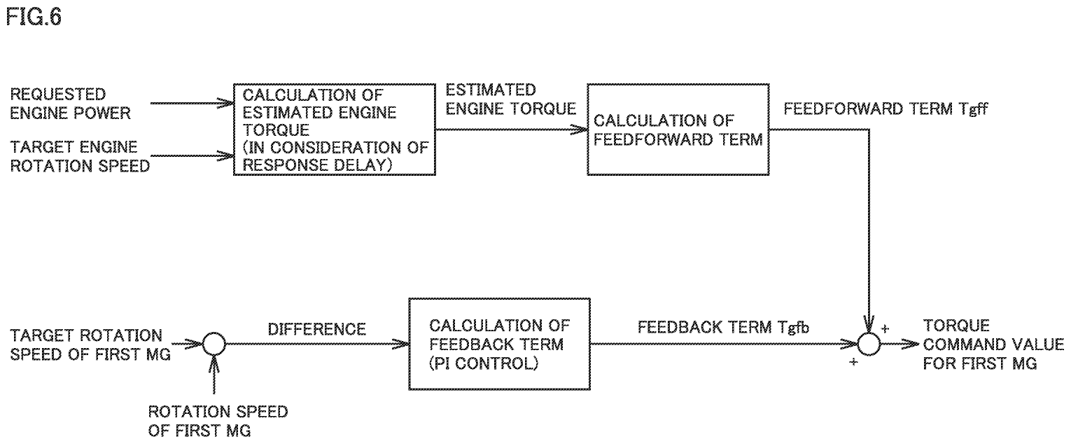

FIG. 6 is a block diagram for illustrating a method of setting a torque command value for first MG 14. As shown in FIG. 6, HV-ECU 62 sets as the torque command value for first MG 14, the sum of a feedforward term Tgff (corresponding to first torque described above) and a feedback term Tgfb (corresponding to second torque described above) in torque control of first MG 14.

HV-ECU 62 calculates, for example, estimated engine torque, converts calculated estimated engine torque into torque to be applied to the output shaft of first MG 14, and calculates torque that cancels converted torque as feedforward term Tgff.

HV-ECU 62 calculates estimated engine torque, for example, in consideration of requested engine power, the target engine rotation speed set in S110, and response delay of engine torque. A method of calculating estimated engine torque will be described later.

HV-ECU 62 further calculates, for example, a difference between a target rotation speed of first MG 14 and the rotation speed of first MG 14, and calculates feedback term Tgfb based on the calculated difference (for example, through PI control).

HV-ECU 62 calculates the target rotation speed of first MG 14 based on a rotation speed of second MG 15 or a vehicle speed, a target engine rotation speed (a rotation speed of carrier C), and a gear ratio among rotary elements of planetary gear mechanism 20.

<As to Calculation of Estimated Engine Torque>

HV-ECU 62 calculates estimated engine torque in consideration of response delay expressed by a certain dead time and a time constant of first-order delay for engine torque calculated by dividing requested engine power by the target engine rotation speed.

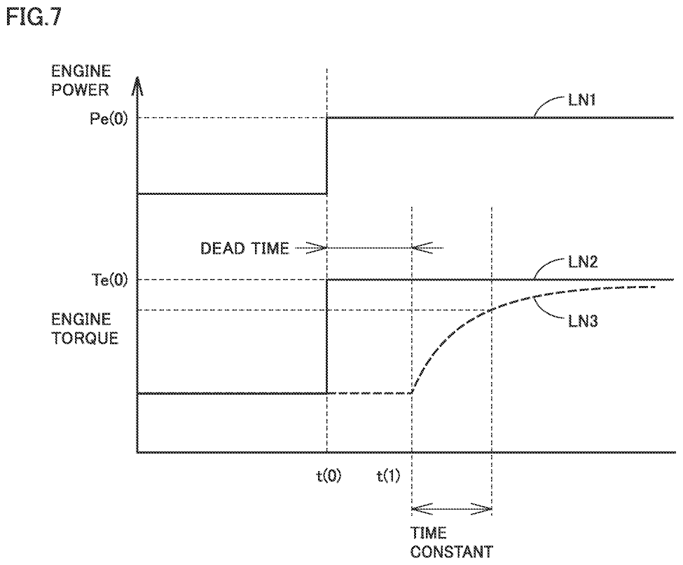

FIG. 7 is a diagram for illustrating a method of calculating estimated engine torque. The ordinate in FIG. 7 represents engine power and engine torque. The abscissa in FIG. 7 represents time. FIG. 7 shows variation in requested engine power LN1 (a solid line). FIG. 7 shows variation in engine torque without taking into account response delay LN2 (a solid line). FIG. 7 shows variation in estimated engine torque in consideration of response delay LN3 (a dashed line).

As shown with LN1 in FIG. 7, for instance, an example in which requested engine power is constant is assumed. When the engine rotation speed is also assumed as being constant, engine torque is also constant.

When requested engine power is assumed to increase stepwise by a prescribed amount and attains to Pe(0) at time t(0), without response delay being taken into account, engine torque attains to a value Te(0) calculated by dividing requested engine power Pe(0) by the engine rotation speed at time t(0) as shown with LN2 in FIG. 7.

Actual variation in engine torque, however, is increase with delay behind increase in requested engine power. Therefore, as shown with LN3 in FIG. 7, HV-ECU 62 calculates estimated engine torque in consideration of response delay expressed by a certain dead time and the time constant of first-order delay for variation in requested engine power.

In the example shown in FIG. 7, HV-ECU 62 calculates estimated engine torque at the current time point on the assumption that increase in engine torque starts from time t(1) after lapse of the certain dead time since time t(0) at which increase in requested engine power started and engine torque varies at the set time constant. By thus taking into account response delay of engine torque, engine torque can accurately be estimated.

In vehicle 10 including turbo charger 47 configured as above, in controlling torque of first MG 14, calculation of estimated engine torque is required for calculating feedforward term Tgff described above. In such a case, engine torque can accurately be estimated by taking into account response delay of engine torque as described above.

In engine 13 including turbo charger 47, however, responsiveness of engine torque is different between the forced induction range in which forced induction by turbo charger 47 is performed and the non-forced induction range and hence engine torque may not accurately be estimated when response delay is taken into account similarly in both of these regions.

In the present embodiment, HV-ECU 62 sets the time constant that determines responsiveness to requested engine power representing an output command, differently between the forced induction range in which forced induction by turbo charger 47 is performed and the non-forced induction range. More specifically, HV-ECU 62 changes the time constant such that a value thereof in the forced induction range where forced induction is performed is greater than a value thereof in the non-forced induction range.

By doing so, an appropriate time constant can be set in each of the forced induction range and the non-forced induction range. Therefore, engine torque can accurately be estimated in each of the forced induction range and the non-forced induction range.

<As to Processing Performed by HV-ECU 62>

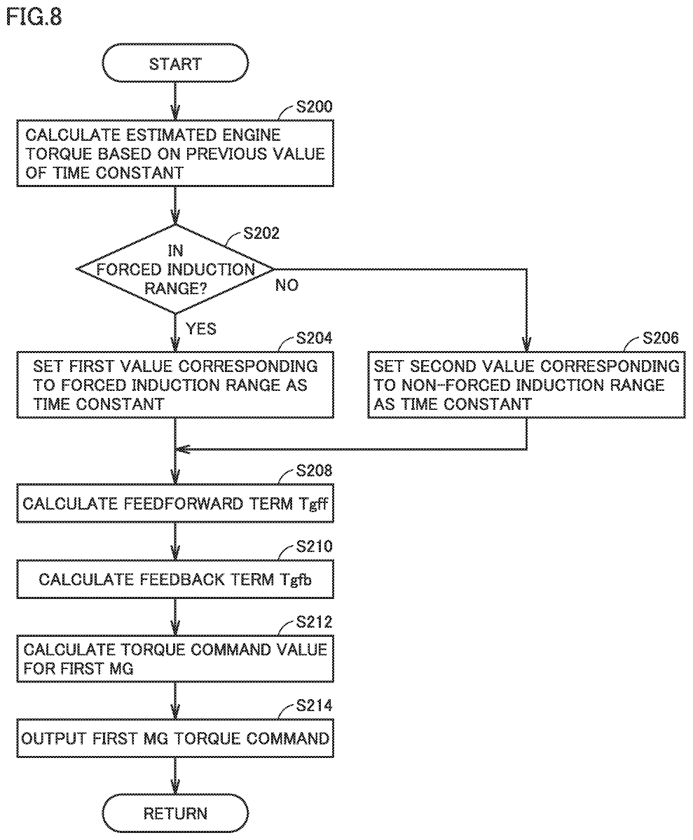

Processing for outputting a first MG torque command performed by HV-ECU 62 will be described below with reference to FIG. 8. FIG. 8 is a flowchart showing exemplary processing for outputting a first MG torque command performed by HV-ECU 62.

In S200, HV-ECU 62 calculates estimated engine torque based on the time constant set in previous calculation (which is denoted as the previous value of the time constant below). Since the calculation method is as described above, detailed description thereof will not be repeated.

In S202, HV-ECU 62 determines whether or not engine torque is in the forced induction range. HV-ECU 62 may determine engine torque as being in the forced induction range, for example, when calculated estimated engine torque is higher than a threshold value. The threshold value is a value for determining whether engine torque is in the forced induction range or the non-forced induction range (a natural aspiration range), and adapted, for example, through experiments. The threshold value may be predetermined, or set, for example, in accordance with an engine rotation speed. The threshold value may be set, for example, such that a value thereof when the engine rotation speed is high is smaller than a value thereof when the engine rotation speed is low. When engine torque is determined as being in the forced induction range (YES in S202), the process proceeds to S204.

In S204, HV-ECU 62 sets a first value corresponding to the forced induction range as the time constant. The first value representing the time constant corresponding to the forced induction range is, for example, a predetermined value adapted through experiments. When engine torque is determined as not being in the forced induction range (that is, in the non-forced induction range) (NO in S202), the process proceeds to S206.

In S206, HV-ECU 62 sets a second value corresponding to non-forced induction as the time constant. The second value representing the time constant corresponding to the non-forced induction range is, for example, a predetermined value adapted through experiments and smaller than the first value.

In S208, HV-ECU 62 calculates feedforward term Tgff. Specifically, HV-ECU 62 calculates estimated engine torque based on the set time constant, converts calculated estimated engine torque into torque to be applied to the rotation shaft of first MG 14, and calculates first torque that cancels converted torque as feedforward term Tgff. When the set time constant is equal to the previous value of the time constant, feedforward term Tgff may be calculated based on estimated engine torque calculated in S200.

In S210, HV-ECU 62 calculates feedback term Tgfb. Since the method of calculating feedback term Tgfb is as described above, detailed description thereof will not be repeated.

In S212, HV-ECU 62 calculates the torque command value for first MG 14. HV-ECU 62 calculates the sum of feedforward term Tgff and feedback term Tgfb as the torque command value for first MG 14.

In S214, HV-ECU 62 outputs the calculated torque command value for first MG 14 as the first MG torque command to MG-ECU 63.

<As to Exemplary Operation by HV-ECU 62>

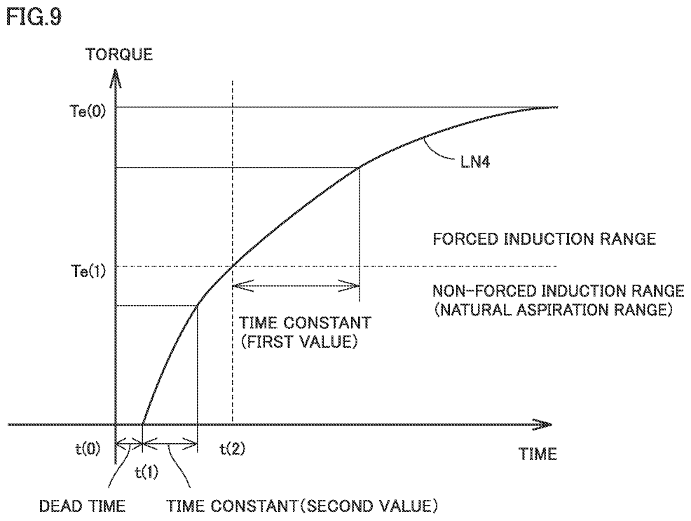

An operation by HV-ECU 62 according to the present embodiment based on the structure and the flowchart as set forth above will be described with reference to FIG. 9. FIG. 9 is a diagram for illustrating an exemplary operation by HV-ECU 62. The ordinate in FIG. 9 represents engine torque. The abscissa in FIG. 9 represents time. FIG. 9 shows variation in estimated engine torque LN4. Requested engine power is assumed to increase stepwise by a prescribed amount and attain to Pe(0) at the time point of time t(0), and thereafter remain constant as seen in variation in requested engine power shown with LN1 in FIG. 7 for the sake of convenience of description.

When requested system power is calculated (S100) and when it is determined that a request for activation of engine 13 has been issued as calculated requested system power has exceeded the threshold value (YES in S102), requested engine power is calculated (S104) and calculated requested engine power is output to engine ECU 64 as the engine operation state command (S106). Then, the intersection between the predetermined operating point and the equal power line of requested engine power is set as the operating point on the predetermined operating line (S108) and the engine rotation speed corresponding to the set operating point is set as the target engine rotation speed (S110).

Estimated engine torque is calculated based on requested system power, the target engine rotation speed, and the previous value of the time constant (S200). When calculated estimated engine torque is equal to or smaller than a threshold value Te(1), engine torque is determined as being in the non-forced induction range (NO in S202) and the second value corresponding to the non-forced induction range is set as the time constant (S206).

For example, when requested engine power increases by a prescribed amount at time t(0), estimated engine torque is calculated to start increase at time t(1) after lapse of the dead time since time t(0) as shown with LN4 in FIG. 9. During a period until time t(2) at which estimated engine torque exceeds threshold value Te(1), estimated engine torque increases in a manner of variation of first-order delay with the second value being set as the time constant.

When estimated engine torque exceeds threshold value Te(1) at time t(2), engine torque is determined as being in the forced induction range (YES in S202) and the first value corresponding to the forced induction range is set as the time constant (S204).

Therefore, when a state that requested engine power is at Pe(0) continues from time t(2), estimated engine torque increases in a manner of variation of first-order delay with the first value being set as the time constant as shown with LN4 in FIG. 9.

When estimated engine torque is calculated, feedforward term Tgff is calculated (S208) based on calculated estimated engine torque and feedback term Tgfb is calculated based on a difference between the target rotation speed of first MG 14 and the first MG rotation speed (S210).

The sum of calculated feedforward term Tgff and feedback term Tgfb is calculated as the torque command value for first MG 14 (S212), and the first MG torque command is output to MG-ECU 63 (S112 and S214) and the second MG torque command is output (S114).

<As to Function and Effect>

As set forth above, according to the hybrid vehicle in the present embodiment, the time constant when engine torque is in the forced induction range is set to be greater than the time constant when engine torque is in the non-forced induction range. Therefore, an appropriate time constant can be set in each of the forced induction range and the non-forced induction range. Therefore, engine torque can accurately be estimated in each of the forced induction range and the non-forced induction range. Accuracy in control of torque of first MG 14 can thus be improved. Therefore, a hybrid vehicle that accurately estimates engine torque in accordance with a state of forced induction by the forced induction device and a method of controlling a hybrid vehicle can be provided.

<As to Modification>

A modification will be described below.

Though intake throttle valve 49 is described as being provided between intercooler 51 and intake manifold 46 in the embodiment above, it may be provided, for example, in intake air passage 41 between compressor 48 and air flow meter 50.

Though the turbo charger is described as an exemplary forced induction device in the embodiment above, the forced induction device is not particularly limited to the turbo charger but may be, for example, a supercharger.

Though a boost pressure is regulated by adjusting a position of waste gate valve 55 according to the description of the embodiment above, the boost pressure may be regulated, for example, by providing a motor generator in a shaft that couples compressor 48 and turbine 53 to each other and controlling a turbine rotation speed by means of the motor generator, or the boost pressure may be regulated by adjusting a gap (a vane position) between adjacent vanes among a plurality of vanes arranged around an outer circumference of a blade of turbine 53.

Though torque of first MG 14 when the engine rotation speed is maintained (that is, when the current engine rotation speed is set as the target value) is calculated as feedforward term Tgff according to the description of the embodiment above, the target value is not limited to the current engine rotation speed but may be set to any value between the current engine rotation speed and the target engine rotation speed.

Though whether engine torque is in the forced induction range or the non-forced induction range is determined based on whether or not estimated engine torque calculated based on the previous value of the time constant is higher than the threshold value according to the description of the embodiment above, engine torque may be determined as being in the forced induction range when the boost pressure detected by boost pressure sensor 72 is higher than the threshold value and as being in the non-forced induction range when the detected boost pressure is equal to or lower than the threshold value.

Though whether engine torque is in the forced induction range or the non-forced induction range is determined based on whether or not estimated engine torque is higher than the threshold value according to the description of the embodiment above, the threshold value may be set in accordance with an atmospheric pressure because relation between a state of forced induction and generated engine torque may be varied by the atmospheric pressure, for example, when a vehicle runs at high altitude.

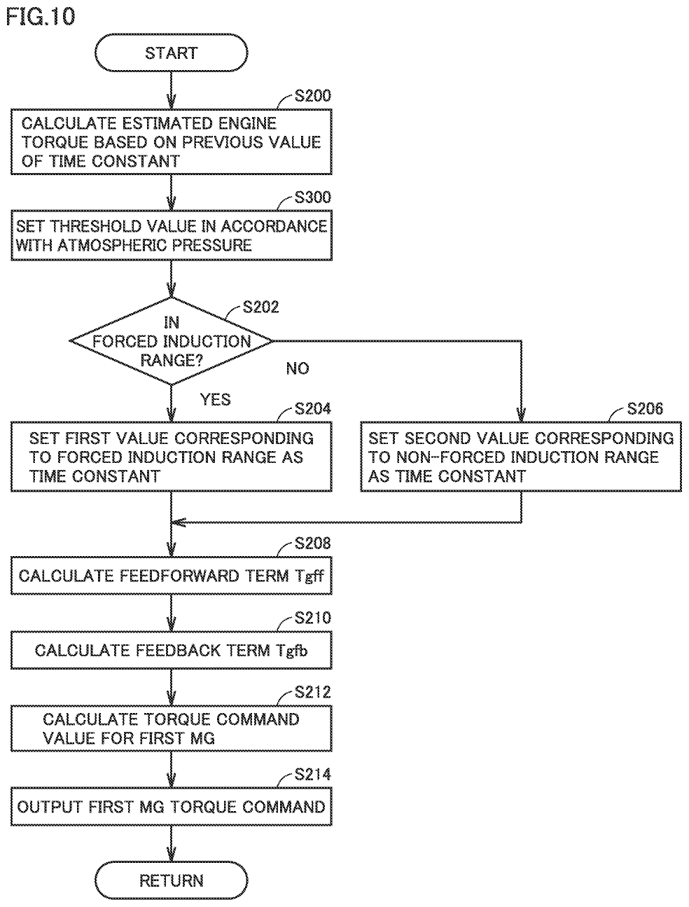

Processing performed by HV-ECU 62 in this modification will be described below with reference to FIG. 10. FIG. 10 is a flowchart showing exemplary processing for outputting the first MG torque command performed by HV-ECU 62 in the modification.

The process in the flowchart in FIG. 10 is different from the flowchart in FIG. 8 in that processing in S300 is performed after processing in S200 and before processing in S202. Since the process is otherwise the same as the process described in the flowchart in FIG. 8, detailed description thereof will not be repeated.

In S300, HV-ECU 62 sets a threshold value in accordance with an atmospheric pressure detected by atmospheric pressure sensor 90. HV-ECU 62 may set a threshold value, for example, based on the atmospheric pressure detected by atmospheric pressure sensor 90 and a prescribed map. The prescribed map shows relation between an atmospheric pressure and a threshold value, and has a boundary value between the forced induction range and the non-forced induction range when the atmospheric pressure is varied in experiments set as the threshold value. The prescribed map is created, for example, to set the threshold value such that the threshold value when the atmospheric pressure is low is smaller than the threshold value when the atmospheric pressure is high.

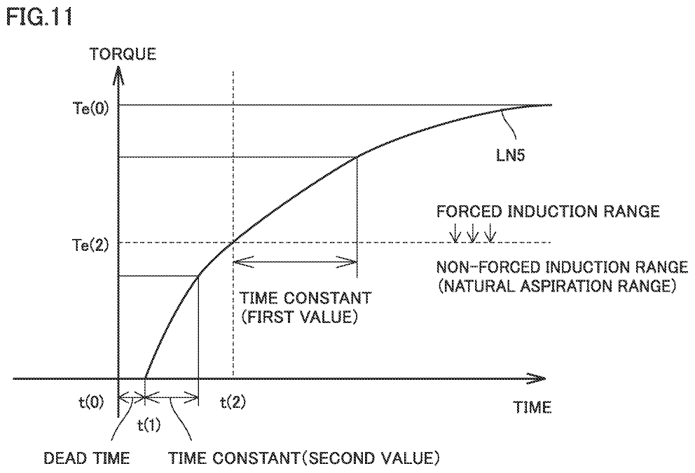

An operation by HV-ECU 62 in this embodiment will be described below with reference to FIG. 11. FIG. 11 is a diagram for illustrating an exemplary operation by HV-ECU 62 in the modification. The ordinate in FIG. 11 represents engine torque. The abscissa in FIG. 11 represents time. FIG. 11 shows variation in estimated engine torque LN5. Requested engine power is assumed to increase stepwise by a prescribed amount and attain to Pe(0) at the time point of time t(0) and thereafter remain constant as seen in variation in requested engine power shown with LN1 in FIG. 7 for the sake of convenience of description. Vehicle 10 running at high altitude (a condition of the low atmospheric pressure) is assumed in the example in FIG. 11 as compared with the example shown in FIG. 9.

When the target engine rotation speed is set in accordance with requested system power (S110), estimated engine torque is calculated based on requested system power, the target engine rotation speed, and the previous value of the time constant (S200). Furthermore, a threshold value Te(2) (<Te(1)) is set based on the atmospheric pressure detected by atmospheric pressure sensor 90 (S300).

When calculated estimated engine torque is equal to or lower than threshold value Te(2), engine torque is determined as being in the non-forced induction range (NO in S202) and the second value corresponding to the non-forced induction range is set as the time constant (S206).

For example, when requested engine power increases by a prescribed amount at time t(0), as shown with LN5 in FIG. 11, estimated engine torque is calculated to start increase at time t(1) after lapse of the dead time since time t(0). During a period until time t(2) at which estimated engine torque exceeds threshold value Te(2), estimated engine torque increases in a manner of variation of first-order delay with the second value being set as the time constant.

When estimated engine torque exceeds threshold value Te(2) at time t(2), engine torque is determined as being in the forced induction range (YES in S202) and the first value corresponding to the forced induction range is set as the time constant (S204).

Therefore, when a state that requested engine power is at Pe(0) continues from time t(2), as shown with LN5 in FIG. 11, estimated engine torque increases in a manner of variation of first-order delay with the first value being set as the time constant.

When estimated engine torque is calculated, feedforward term Tgff is calculated based on calculated estimated engine torque (S208) and feedback term Tgfb is calculated based on a difference between the target rotation speed of first MG 14 and the first MG rotation speed (S210).

The sum of calculated feedforward term Tgff and feedback term Tgfb is calculated as the torque command value for first MG 14 (S212) and the first MG torque command is output to MG-ECU 63 (S214).

By doing so, even though responsiveness of engine torque is varied with variation in atmospheric pressure, the time constant can be changed in accordance with the state of forced induction by turbo charger 47. Therefore, engine torque can accurately be estimated in each of the forced induction range and the non-forced induction range. The threshold value for determining whether or not engine torque is in the forced induction range is not limited to the threshold value set in accordance with variation in atmospheric pressure as described above but may be set, for example, in accordance with a position of the EGR valve, timing to open and close the intake valve or the exhaust valve, or a state of operation such as an amount of lift.

The modification above may be carried out as being combined in its entirety or in part as appropriate.

Though an embodiment of the present invention has been described, it should be understood that the embodiment disclosed herein is illustrative and non-restrictive in every respect. The scope of the present invention is defined by the terms of the claims and is intended to include any modifications within the scope and meaning equivalent to the terms of the claims.

What is claimed is:

1. A hybrid vehicle comprising:
an engine including a forced induction device;
a motor generator that generates electric power by using motive power of the engine;
a power divider that divides motive power output from the engine into motive power to be transmitted to the motor generator and motive power to be transmitted to a drive wheel; and
a controller that carries out torque control of the motor generator for setting a rotation speed of the engine to a target value by using engine torque estimated in consideration of responsiveness to an output command to the engine,
the controller setting a time constant that determines the responsiveness differently between a forced induction range in which forced induction by the forced induction device is performed and a non-forced induction range.

2. The hybrid vehicle according to claim 1, wherein
the controller changes the time constant such that a value of the time constant in the forced induction range is greater than a value of the time constant in the non-forced induction range.

3. The hybrid vehicle according to claim 1, further comprising a detector that detects an atmospheric pressure, wherein
the controller determines the engine torque as being in the forced induction range when the engine torque exceeds a threshold value,
the controller determines the engine torque as being in the non-forced induction range when the engine torque is lower than the threshold value, and
the controller sets the threshold value such that the threshold value when the atmospheric pressure is low is smaller than the threshold value when the atmospheric pressure is high.

4. A method of controlling a hybrid vehicle, the hybrid vehicle including an engine including a forced induction device, a motor generator that generates electric power by using motive power of the engine, and a power divider that divides motive power output from the engine into motive power to be transmitted to the motor generator and motive power to be transmitted to a drive wheel, the method comprising:
carrying out torque control of the motor generator for setting a rotation speed of the engine to a target value by using engine torque estimated in consideration of responsiveness to an output command to the engine; and
setting a time constant that determines the responsiveness differently between a forced induction range in which forced induction by the forced induction device is performed and a non-forced induction range.
